(19) United States
(12) Patent Application Publication
(10) Pub. No.: US 2024/0303715 A1
(43) Pub. Date: Sep. 12, 2024

(54) INFORMATION PROCESSING APPARATUS

(71) Applicant: TOYOTA JIDOSHA KABUSHIKI KAISHA, Toyota-shi (JP)

(72) Inventors: Lukas FRANNEK, Tokyo-to (JP); Narimasa WATANABE, Tokyo-to (JP); Toshiyuki SAKAMOTO, Tokyo-to (JP)

(73) Assignee: TOYOTA JIDOSHA KABUSHIKI KAISHA, Toyota-shi (JP)

(21) Appl. No.: 18/598,657

(22) Filed: Mar. 7, 2024

(30) Foreign Application Priority Data
Mar. 7, 2023 (JP) 2023-034977

(51) Int. Cl. G06Q 30/0601

(52) U.S. Cl. CPC G06Q 30/0631

(57) ABSTRACT

An information processing apparatus includes a controller configured to execute operations, the operations including extracting text information regarding a shop from content of the shop, generating a content value vector in a plurality of dimensions based on the text information, calculating a person parameter for a user based on information input by the user, generating a user preference value vector in the plurality of dimensions based on the person parameter, and determining a similarity between the content value vector and the user preference value vector.

### CROSS-REFERENCE TO RELATED APPLICATION

This application claims priority to Japanese Patent Application No. 2023-034977, filed on Mar. 7, 2023, the entire contents of which are incorporated herein by reference.

### TECHNICAL FIELD

The present disclosure relates to an information processing apparatus.

### BACKGROUND

Technology for presenting information on restaurants such that the degree to which taste tendency information for the restaurants acquired from a restaurant database matches preference information for users obtained from questionnaires is equal to or greater than a predetermined value is known. For example, see Patent Literature (PTL) 1.

### CITATION LIST

### Patent Literature

PTL 1: JP 2021-125260 A

### SUMMARY

In the above background technology, restaurants are evaluated only on taste-related evaluations. Therefore, other information on taste may not match the users' preferences and the users' satisfaction may not be achieved.

It would be helpful to evaluate content that further matches a user's preference.

An information processing apparatus according to an embodiment of the present disclosure is an information processing apparatus including a controller configured to execute operations, the operations including:
extracting text information regarding a shop from content of the shop;
generating a content value vector in a plurality of dimensions based on the text information;
calculating a person parameter for a user based on information input by the user;
generating a user preference value vector in the plurality of dimensions based on the person parameter; and
determining a similarity between the content value vector and the user preference value vector.

According to an embodiment of the present disclosure, content that further matches a user's preference can be evaluated.

### BRIEF DESCRIPTION OF THE DRAWINGS

In the accompanying drawings:

FIG. 1 is a schematic diagram of an information processing system;

FIG. 2 is a block diagram illustrating a configuration of an information processing apparatus;

FIG. 3 is a block diagram illustrating a configuration of a user terminal;

FIG. 4 is a diagram illustrating a data structure of a similarity database (DB); and

FIG. 5 is a flowchart illustrating operations by the information processing apparatus.

### DETAILED DESCRIPTION

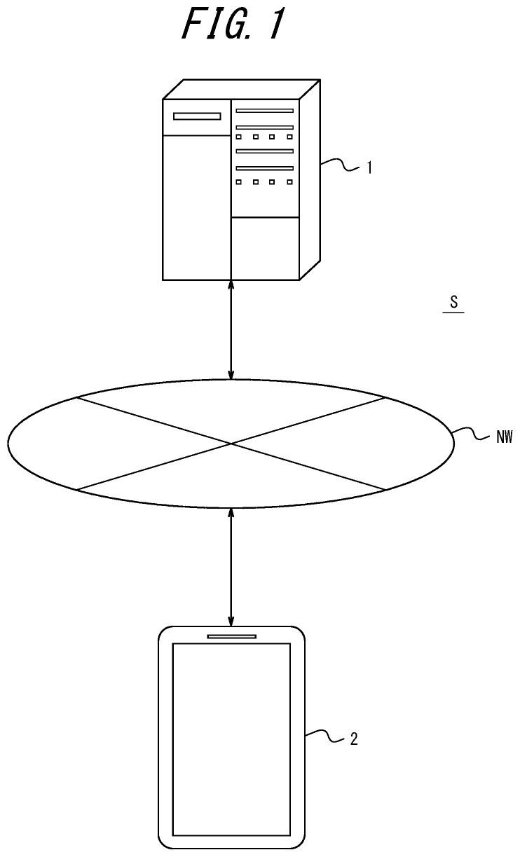

FIG. 1 is a schematic diagram of an information processing system S according to the present embodiment. The information processing system S includes an information processing apparatus 1 and a user terminal 2, which are communicably connected to each other via a network NW. The network NW includes, for example, a mobile communication network, a fixed communication network, or the Internet.

FIG. 1 illustrates one of the information processing apparatus 1 and one of the user terminal 2, for convenience of explanation. However, the number of information processing apparatuses 1 and the number of user terminals 2 are not limited to one. For example, processing to be executed by the information processing apparatus 1 according to the present embodiment may be executed by a plurality of distributed information processing apparatuses 1.

The information processing apparatus 1 is installed in a facility such as a data center. The information processing apparatus 1 is a computer such as a server that belongs to a cloud computing system or another type of computing system.

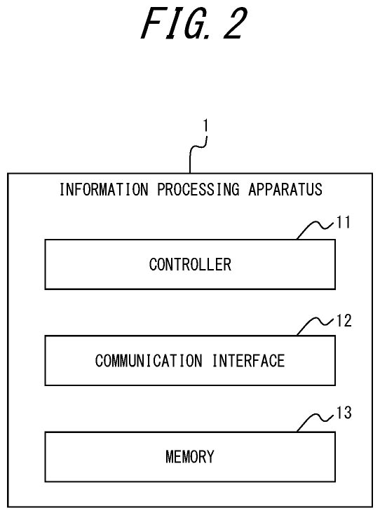

With reference to FIG. 2, an internal configuration of the information processing apparatus 1 will be described in detail.

The information processing apparatus 1 includes a controller 11, a communication interface 12, and a memory 13. The components of the information processing apparatus 1 are communicably connected to one another via, for example, dedicated lines.

The controller 11 includes, for example, one or more general purpose processors including a Central Processing Unit (CPU) or a Micro Processing Unit (MPU). The controller 11 may include one or more dedicated processors that are dedicated to specific processing. The controller 11 may include one or more dedicated circuits instead of the processors. Examples of the dedicated circuits may include a Field-Programmable Gate Array (FPGA) and an Application Specific Integrated Circuit (ASIC). The controller 11 may include an Electronic Control Unit (ECU). The controller 11 transmits and receives any information via the communication interface 12.

The communication interface 12 includes one or more communication modules for connection to the network NW that conform to wired or wireless Local Area Network (LAN) standards. The communication interface 12 may include a module conforming to one or more mobile communication standards including the Long Term Evolution (LTE) standard, the 4th Generation (4G) standard, or the 5th Generation (5G) standard. The communication interface 12 may include one or more communication modules conforming to near field communication standards or specifications, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 transmits and receives any information via the network NW.

The memory 13 includes, for example, a semiconductor memory, a magnetic memory, an optical memory, or a combination of at least two of these, but is not limited to these. The semiconductor memory is, for example, RAM or ROM. The RAM is, for example, SRAM or DRAM. The ROM is, for example, EEPROM. The memory 13 may function as, for example, a main memory, an auxiliary memory, or a cache memory. The memory 13 may store information resulting from analysis or processing performed by the controller 11. The memory 13 may store various types of information or the like regarding operations and control of the information processing apparatus 1. The memory 13 may store a system program, an application program, embedded software, and the like. The memory 13 may be provided outside the information processing apparatus 1 and accessed by the information processing apparatus 1. The memory 13 includes a similarity DB.

The user terminal 2 is, for example, a mobile device such as a mobile phone, a smartphone, a wearable device, or a tablet. As an alternative example, the user terminal 2 may be a general purpose device such as a PC, or a dedicated device. The term “PC” is an abbreviation of personal computer.

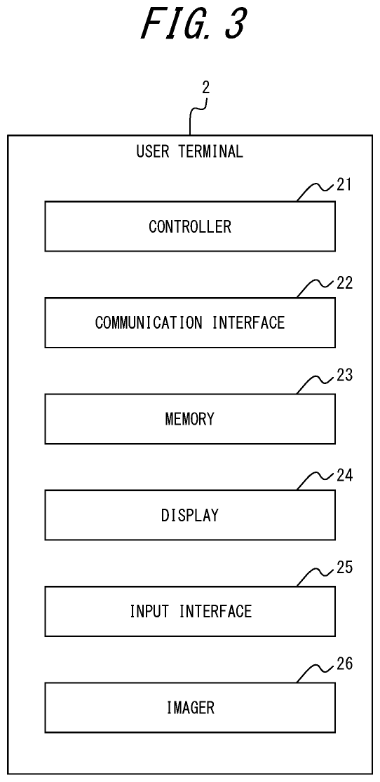

With reference to FIG. 3, an internal configuration of the user terminal 2 will be described in detail.

The user terminal 2 includes a controller 21, a communication interface 22, a memory 23, a display 24, an input interface 25, and an imager 26. The components of the user terminal 2 are communicably connected to one another, for example, via dedicated lines.

Descriptions of the hardware configurations of the controller 21, the communication interface 22, and the memory 23 of the user terminal 2 may be the same as the descriptions of the hardware configurations of the controller 11, the communication interface 12, and the memory 13 of the information processing apparatus 1, respectively. An explanation here is omitted.

The display 24 is, for example, a display. The display is, for example, an LCD or an organic EL display. The term “LCD” is an abbreviation of liquid crystal display. The term “EL” is an abbreviation of electro luminescence. The display 24, instead of being included in the user terminal 2, may be connected to the user terminal 2 as an external output device. As a connection method, any technology such as USB, HDMI® (HDMI is a registered trademark in Japan, other countries, or both), or Bluetooth® can be used.

The input interface 25 is, for example, a physical key, a capacitive key, a pointing device, a touch screen integrally provided with a display, or a microphone. The input interface 25 accepts an operation for inputting information to be used for the operations of the user terminal 2. The input interface 25, instead of being included in the user terminal 2, may be connected to the user terminal 2 as an external input device. As a connection method, any technology such as USB, HDMI® (HDMI is a registered trademark in Japan, other countries, or both), or Bluetooth® can be used. The term “USB” is an abbreviation of Universal Serial Bus. The term “HDMI®” is an abbreviation of High-Definition Multimedia Interface.

The imager 26 includes a camera. The imager 26 can capture an image of surroundings. The imager 26 may store the captured image in the memory 23 or transmit the captured image to the controller 21 for the purpose of image analysis. Images include still or moving images.

Hereinafter, an information processing method executed in the information processing system S will be described in detail.

The controller 11 of the information processing apparatus 1 extracts text information regarding a shop from the content of any or specific shops by scraping, purchasing a database, or collecting via Web API. The shops may be, for example, massage parlors, karaoke parlors, and restaurants. The content may include, for example, tags, descriptions, or reviews. The tags may be, for example, “porridge”, “calories”, “kebab”, “standing food”, “French”. Descriptions could be, for example, “It is a stylish restaurant,” “friendly and courteous service,” or “special ingredients. Reviews may be, for example, “crowded,” “one person OK,” or “delicious.

The controller 11 generates a descriptive text vector from the extracted text information and a content value vector of a plurality of dimensions from the descriptive text vector. The dimensions of the content value vector are, for example, the following 10.
Dimension 1: Famousness (this indicates that the user wants to go to a famous place)
Dimension 2: Challenge (this indicates that the user wants a challenge)
Dimension 3: Sympathy (this indicates that the user wants to benefit others)
Dimension 4: Low price (this indicates that the user wants to go to a low-priced place)
Dimension 5: Rating (this indicates that the user wants to go to places that are highly rated by others)
Dimension 6: Health (this indicates that the user wants to be healthy)
Dimension 7: Preferences (this indicates what the user prefers to do)
Dimension 8: Seasonality (this indicates that the user can only do this now)
Dimension 9: Attachment (this indicates that the user wants to go to a familiar place)
Dimension 10: Coupling (this indicates that the user wants to connect with someone)

The following algorithms may be used in the generation of content value vectors.
Data Augmentation
Sentence-BERT
SBERT-WK
Bert-fine
Fine Tuning

Algorithms used in the generation are not limited to those listed above, but may be selected arbitrarily from those well-known in the past. The algorithms may be based on Artificial Intelligence (AI). A detailed description of the process performed by the algorithm is omitted here.

For example, in generating content value vectors, the controller 11 automatically extracts representative words from text information to create a vocabulary (lexicon). The controller 11 uses morphological analysis to fix the part of speech to be extracted, such as noun or object. The controller 11 extracts words so that they are distributed as much as possible in the vector space output in the generation of the explanatory sentence vector. Representative words are used to generate training data.

The controller 11 manually scores each of the extracted words (in this case, “fashionable,” “quiet,” and “can fill up”) by the user as follows.

| | |
|---|---|
| Stylish | Extroversion 80% |
| Quiet | Introversion 60% |

Have a full stomach Focus on cost performance 90%

Furthermore, the controller 11 uses the combinatorial logic of data augmentation to generate the following descriptive sentence vector.

| | |
|---|---|
| A quiet place to fill up! | (0.0, 0.6, 0.9) |
| The restaurant was stylish. | (0.8, 0.0, 0.0) |

The controller 11 generates content value vectors in a plurality of dimensions from the descriptive text vector. The controller 11 can learn a model to generate content value vectors from the content of the shop.

The controller 11 calculates person parameters for the user from information input by the user. Input information includes, for example, information entered in a questionnaire. Specifically, the input information includes at least one of the following: discrete data, numerical data, and numerical and discrete data. For example, if a survey asks, “How many stars would you give to the question,” the answer to that question is numerical data. The answer to the question “Choose all that apply” is a vector consisting of 1s or 0s, and therefore is discrete data. The answer to the question “What is your last Education®” is numerical and discrete data, since it is a numerical value and a one-hot vector.

The controller 11 aggregates the input information horizontally (i.e., by the same respondent) and vertically (i.e., multiple respondents together). In the longitudinal aggregation, averaging, dispersion, normalization, etc. may be performed. The person parameters indicate, for example, health orientation score, extraversion score, interaction orientation score, health orientation score, etc.

The controller 11 generates a user preference value vector based on the calculated person parameters in the same plurality of dimensions used in the content value vector. Any estimation model using algorithms such as Feature Engineering may be used in the generation of user preference value vectors. The controller 11 can determine which dimension of the user preference value vector is relatively high for each user. The controller 11 can learn a model that generates a user preference value vector from the person parameters.

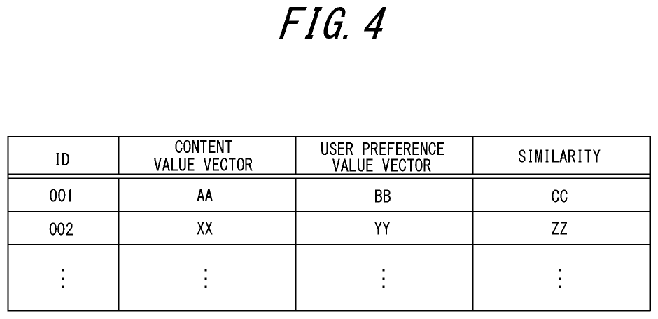

As illustrated in FIG. 4, the controller 11 stores the content value vector of each content and the user preference value vector of each user in the similarity DB in association with the ID. The controller 11 quantifies and determines the similarity (affinity) between the content value vector and the user preference value vector. The similarity may be determined by cosine similarity, Euclidean distance, mean squared error, or machine learning models, with ranking algorithms.

When the user terminal 2 receives a requesting operation from the user on the display 24 or the input interface 25, it sends the request to the information processing apparatus 1. The request may be, for example, “I want to relax,” “I want to eat,” or “I want to play sports. When the controller 11 of the information processing apparatus 1 receives the request, it extracts choices of shops. The controller 11 generates a content value vector for each choice.

The controller 11 generates a user preference value vector for each user of the user terminal 2. The controller 11 presents one or more shops corresponding to the content value vector with the highest similarity (or higher than the standard value) to the calculated user preference value vector to the user terminal 2. The similarity here corresponds to height of happiness.

When the controller 21 of user terminal 2 receives a choice from the user for one of the choices, it proposes to make a reservation at the shop corresponding to the selected choice. The controller 21 can accept reservation requests from users to reserve shops.

As an additional or alternative example, when the controller 21 receives a requesting operation from multiple users belonging to the same group (e.g., collective action members), it may determine the similarity for each user and notify each user's user terminal of the determination result.

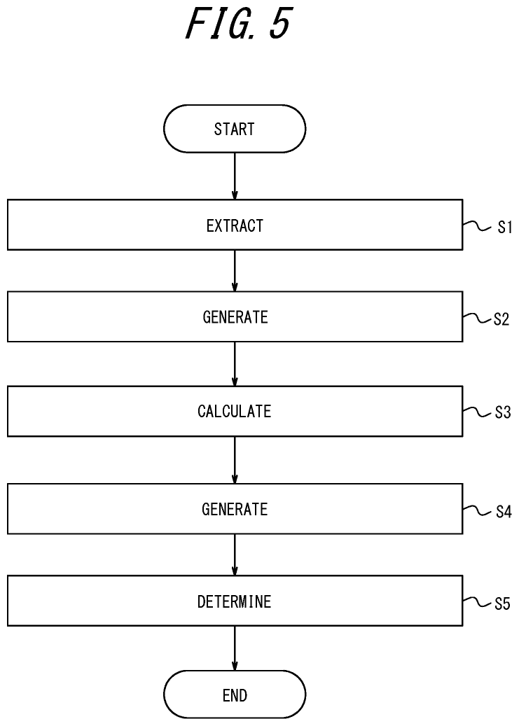

An information processing method by the information processing apparatus 1 will be described with reference to FIG. 5.

In step S1, the controller 11 extracts text information regarding the shop from the content of the shop. In step S2, the controller 11 generates content value vectors in a plurality of dimensions from the text information.

In step S3, the controller 11 calculates person parameters for the user from information input by the user. In step S4, the controller 11 generates a user preference value vector in a plurality of dimensions from the person parameters. Steps S1 and S2 and steps S3 and S4 may be performed in reverse order.

In step S5, the controller 11 determines the similarity between the content value vector and the user preference value vector.

As described above, according to the present embodiment, the controller 11 executes operations including extracting text information regarding the shop from the content of the shop, generating a content value vector in a plurality of dimensions from the text information, calculating a person parameter for the user based on information input by the user, generating a user preference value vector in a plurality of dimensions based on the person parameter, and determining the similarity between the content value vector and the user preference value vector. This configuration enables the information processing apparatus 1 to evaluate shops in a plurality of dimensions, so it can evaluate content that further matches the user's preferences.

According to the present embodiment, the similarity is determined by cosine similarity, Euclidean distance, mean squared error, or a machine learning model with a ranking algorithm. With this configuration, the information processing apparatus 1 can determine the similarity more accurately.

According to the present embodiment, the operations of the controller 11 also include acquiring content of the shop and generating a content value vector using a predetermined algorithm. With this configuration, the information processing apparatus 1 can quantify the content value of the shop.

According to the present embodiment, the operations of the controller 11 also include learning a model that generates a user preference value vector from the person parameters. This configuration allows the information processing apparatus 1 to improve the accuracy of generating user preference value vectors.

According to the present embodiment, the operations of the controller 11 also include notifying the user of one or more choices of shops based on the height of the determined similarity when a requesting operation is accepted from the user. This configuration allows the information processing apparatus 1 to evaluate the user happiness for each choice proposed to the user. The information processing apparatus 1 can further evaluate individual elements of user-happiness by using a vector of a plurality of dimensions.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined into one or divided.

For example, in the aforementioned embodiment, a program configured to execute all or some of the functions or processing of the information processing apparatus 1 can be recorded on a computer readable recording medium. The computer readable recording medium includes a non-transitory computer readable medium and is, for example, a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may be provided as a program product. The present disclosure can also be implemented as a program executable by a processor.

1. An information processing apparatus comprising a controller configured to execute operations, the operations comprising:
extracting text information regarding a shop from content of the shop;
generating a content value vector in a plurality of dimensions based on the text information;
calculating a person parameter for a user based on information input by the user;
generating a user preference value vector in the plurality of dimensions based on the person parameter; and
determining a similarity between the content value vector and the user preference value vector.

2. The information processing apparatus according to claim 1, wherein the similarity is determined by cosine similarity, Euclidean distance, mean squared error, or a machine learning model using a ranking algorithm.

3. The information processing apparatus according to claim 1, wherein the operations comprise acquiring the content of the shop and generating the content value vector using a predetermined algorithm.

4. The information processing apparatus according to claim 1, wherein the operations comprise training a model for generating the user preference value vector based on the person parameter.

5. The information processing apparatus according to claim 1, wherein the operations comprise notifying the user of one or more choices of shops based on height of the determined similarity upon accepting a requesting operation from the user.
